(19) United States
(12) Patent Application Publication
(10) Pub. No.: US 2006/0256440 A1
(43) Pub. Date: Nov. 16, 2006

(54) Automobile front-seat light-filter glass

(75) Inventor: Chin-Fu Chuang, Tainan City (TW)

Correspondence Address: Chin-Fu CHUANG, P.O. Box 6-9 (717), Tainan, TW

(73) Assignee: CROWNRAY OPTIC CO., LTD

(21) Appl. No.: 11/128,385

(22) Filed: May 13, 2005

(51) Int. Cl. G02B 17/00

(52) U.S. Cl. 359/601; 296/97.1

(57) ABSTRACT

An automobile front-seat light-filter glass includes a shade plate and two light-filer glasses. The two light-filer glasses are respectively and pivotally connected with the front surface and the rear surface of the shade plate by means of two pairs of hinges so as to let the filter glasses be folded down and up. One of the filter glasses is used for filtering strong sunlight during daytime, and the other is used for filtering strong light of headlights of an automobile, for keeping safety of an automobile in running during both daytime and nighttime.

### BACKGROUND OF THE INVENTION

1. Field of the Invention

This invention relates to an automobile front-seat light-filter glass, particularly to one consisting of a shade plate and two different light-filter glasses, one being for daytime and the other for nighttime to be optionally used to keep safety of an automobile in running.

2. Description of the Prior Art

A conventional automobile front-seat light-filter glass is usually pivotally connected with a sunlight shading plate for filtering strong sunlight in case of need by a driver, but sometimes may drop off the shading plate because of bumping of an automobile. Moreover, the front-seat light-filter glass is not so suitable for weakening strong light of headlights of an automobile coming from the front directions, dazzling the eyes of a driver.

### SUMMARY OF THE INVENTION

The feature of the invention is two light-filter glasses pivotally connected with a shade plate and optionally used during daytime or nighttime, with the shade plate combined with a horizontal rod of the sunlight shading plate originally provided in front of a driver's seat, by removing the original sunlight shading plate.

### BRIEF DESCRIPTION OF DRAWINGS

This invention will be better understood by referring to the accompanying drawings, wherein:

FIG. 1 is an exploded perspective view of an automobile front seat light-filter glass in the present invention;

FIG. 2 is a perspective view of the automobile front-seat light-filter glass in the present invention;

FIG. 3 is a side view of the automobile front-seat light-filter glass in the present invention, showing it used in nighttime; and,

FIG. 4 is a side view of the automobile front-seat light-filter glass in the present invention, showing it used in daytime.

### DETAILED DESCRIPTION OF THE PREFERRED EMBODIMENT

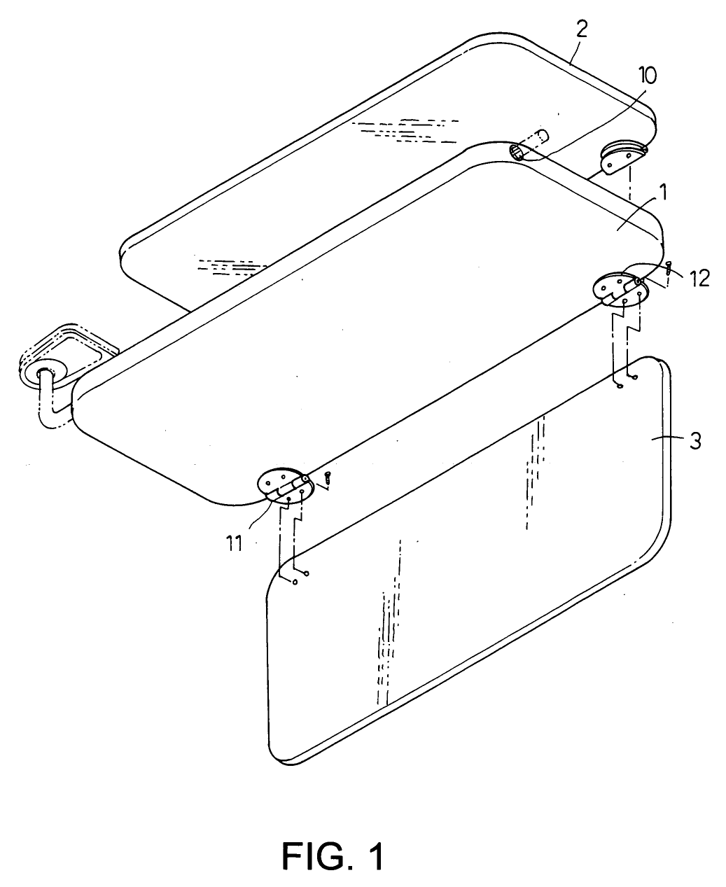

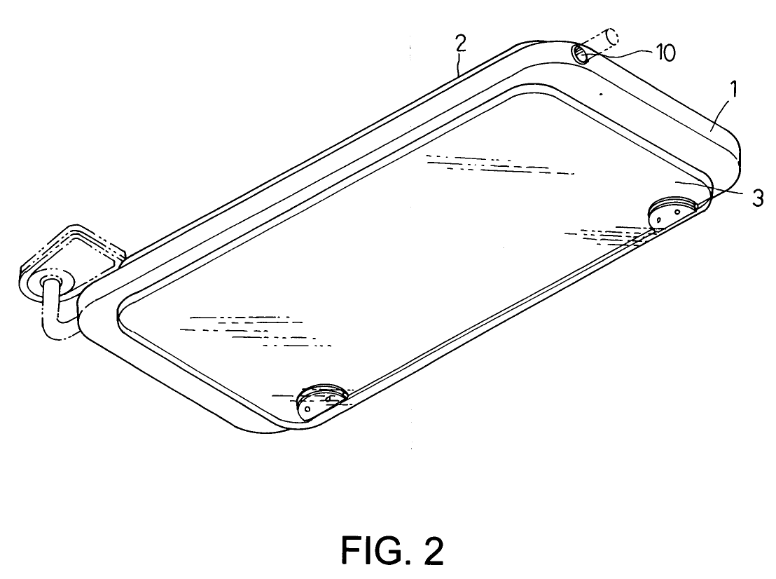

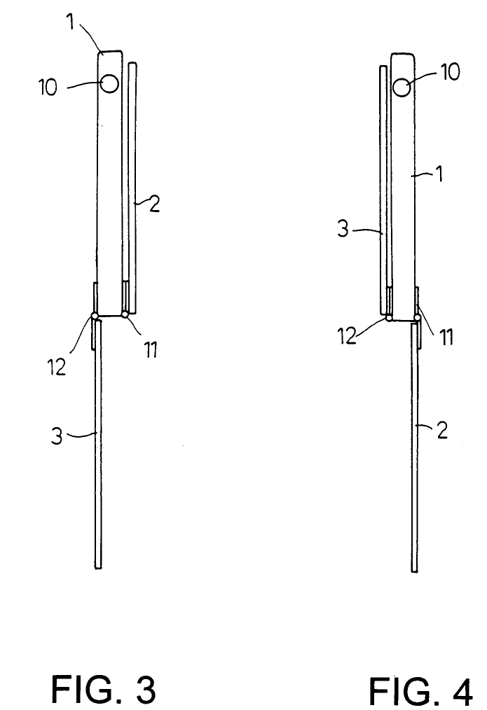

A preferred embodiment of an automobile front-seat light-filter glass in the present inventin, as shown in FIGS. 1 to 4, includes a shading plate 1, a daytime filter glass 2, and a nighttime filter glass 3, combined together.

The shading plate 1 is fixed in front of a driver's or front seat, having a pivot hole 10 in an upper end and pivotally connected with the horizontal rod of the sunlight shading plate of an automobile. The shade plate 1 further has two pairs of hinges 11 and 12 respectively fixed on the front side and the rear side of the lower end, and the front two hinges 11 pivotally connect the daytime filter glass 2, and the rear two hinges 12 pivotally connect the nighttime filter glass 3. Further, the daytime filter glass 2 is made of dark brown colored material, but the nighttime filter glass 3 is made of yellow colored material.

In assembling and using, the original front-seat sunlight shading plate is in advance replaced by the shade plate 1, by fitting the pivot hole 10 with the horizontal rod of the original sunlight shading plate, finishing assembling. Then a driver can use the front-seat light-filter glasses, and if used in daytime, the daytime filter glass 2 is pivotally folded down from the shade plate 1. If used in nighttime, the nighttime filer glass 3 is pivotally folded down from the shade plate 1, with the daytime filter glass 2 still remained with the shade plate 1.

The invention has the following advantages as can be understood from the foresaid description.
1. It is directly combined with the horizontal rod of the original sunlight shading plate, very simple to handle, never falling off.
2. It has two different light-filter glasses for optionally used in daytime or nighttime, very convenient to be handled.
3. The daytime and the nighttime filter glasses are all pivotally connected with the shade plate with hinges, easy to be folded down and up for use.

While the preferred embodiment of the invention has been described above, it will be recognized and understood that various modifications may be made therein and the appended claims are intended to cover all such modifications that may fall within the spirit and scope of the invention.

What is claimed is:

1. An automobile front-seat light-filter glass comprising:
a shade plate combined with a horizontal rod of a sunlight shading plate of an automobile and having two pairs of hinges respectively fixed spaced apart on two sides of a lower end of a front surface and of a rear surface; and,
two filter glasses pivotally and respectively connected with said shade plate by means of said two pairs of hinges.

2. The automobile front-seat light filter glass as claimed in claim 1, wherein one of said filer glasses is made of dark brown colored material to be used during daytime, and the other of said filter glasses is made of yellow colored material to be used during nighttime.

3. The automobile front-seat light-filter glass as claimed in claim 1, wherein said shade plate is made of material not letting light pass through.

4. The automobile front-seat light-filter glass as claimed in claim 1, wherein said hinges fixed on said shade plate has pivotal members to let said filer glasses to be folded up and down from said shade plate.
